(19) United States
(12) Patent Application Publication
(10) Pub. No.: US 2005/0147445 A1
(43) Pub. Date: Jul. 7, 2005

(54) Ink jet printer

(76) Inventor: Masaaki Tsuji, Osaka (JP)

Correspondence Address: FULBRIGHT & JAWORSKI, LLP, 666 FIFTH AVE, NEW YORK, NY, 10103-3198, US

(21) Appl. No.: 11/010,231

(22) Filed: Dec. 10, 2004

(30) Foreign Application Priority Data
Dec. 11, 2003 (JP) PAT. 2003-413396

(51) Int. Cl. B41J 2/25

(52) U.S. Cl. 400/124.1

(57) ABSTRACT

An ink jet printer includes a print head operable back and forth along a main scanning direction, a transport mechanism for transporting a print medium along a sub scanning direction intersecting the main scanning direction, and a discharge control mechanism for causing ink to be discharged from a nozzle of the print head. The print head is mounted on a carriage supported, via a circulatory rolling guide mechanism, on a guide rail extending along the main scanning direction. The ink jet printer outputs on the print medium an image having resolution of 700 dpi or higher. The circulatory rolling guide mechanism is configured as a preloaded type mechanism providing its roller members with a preload; and the roll members of the circulatory rolling guide mechanism have a diameter of about 2.8 mm or less.

### BACKGROUND OF THE INVENTION

1. Field of the Invention

The present invention relates to an ink jet printer, more particularly to an ink jet printer including a print head operable back and forth along a main scanning direction, a transport mechanism for transporting a print medium along a sub scanning direction intersecting the main scanning direction, and a discharge control mechanism for causing ink to be discharged from a nozzle of the print head, the print head being mounted on a carriage supported, via a circulatory rolling guide mechanism, on a guide rail extending along the main scanning direction.

2. Description of the Related Art

An ink jet printer of the above-noted type is known from e.g. Japanese Patent Application “Kokai” No. 8-108530. With the ink jet printer disclosed in this document, a printer mounting plate having a print head is slidably engaged with a guide rail via a linear guide bearing mechanism (circulatory rolling guide mechanism). Hence, a smooth sliding operation of the print head can be expected with reduced looseness in the sub scanning direction in particular.

The above document does not elaborate about the circulatory rolling guide mechanism employed therein. However, if a preloaded type mechanism providing its roller members with a preload is employed as this mechanism, this will further reduce the looseness, if any, between the circulatory rolling guide mechanism and the guide rail. As a result, the sub-scanning direction-wise, positioning precision of the print head relative to the guide rail will be further improved, hence improving the quality of the formed image.

As a matter of fact, it has been found that mere application of such preloaded type circulatory rolling guide mechanism to a carriage of an ink jet printer tends to invite streak-like irregularity defect extending along the sub scanning direction in the outputted image. The probable cause of this phenomenon is a small ripple in the carriage or the print head due to a shock occurring at the moment when the roller members (e.g. a steel balls) employed in the circulatory rolling guide mechanism experience elastic deformation when entering a loaded region from an un-loaded region as well as when entering the un-loaded region from the loaded region, thus being released from the preload.

### SUMMARY OF THE INVENTION

A primary object of the present invention is to provide an ink jet printer including a circulatory rolling guide mechanism which is configured as the preloaded type for image quality improvement, yet the printer hardly inviting the streak-like irregularity defect in the outputted image due to the small ripple in the carriage or the print head thereof.

For accomplishing the above-noted object, an ink jet printer, according to the present invention, comprises:
a print head operable back and forth along a main scanning direction;
a transport mechanism for transporting a print medium along a sub scanning direction intersecting the main scanning direction;
a discharge control mechanism for causing ink to be discharged from a nozzle of the print head, and
the print head being mounted on a carriage supported, via a circulatory rolling guide mechanism, on a guide rail extending along the main scanning direction;
wherein said ink jet printer outputs on the print medium an image having resolution of 700 dpi or higher; the circulatory rolling guide mechanism is configured as a preloaded type mechanism providing its roller members with a preload; and said roll members of the circulatory rolling guide mechanism have a diameter of about 2.8 mm or less.

Through extensive and intensive study on relationship between various sizes of the roller member and the resultant quality variations in outputted images, the present inventors found that the ink jet printer having the above-described features can provide an image substantially free from the defect. While not wishing to be bound by any particular theory, it is believed that the above-specified size (about 2.8 mm or less in diameter) of the roller member (e.g. a ball bearing or its carriage) is just needed and sufficient for realizing its smooth slidable engagement with the guide rail by reducing the amount of elastic deformation occurring in the roller member when entering or exiting the loaded region in connection with the defined image resolution of the ink jet printer. In other words, with the construction proposed above, the amount of ripple to occur can be reduced and also the ripple will be of higher frequency.

Further and other features and advantages of the invention will become apparent upon reading following detailed description of its preferred embodiment with reference to the accompanying drawings.

### BRIEF DESCRIPTION OF THE DRAWINGS

FIG. 1 is an overall side view of a print system,

FIG. 2 is a perspective view of a print station,

FIG. 3 is a diagram showing image printed areas and a cut mark,

FIG. 4 is a diagram showing a transport path of a print paper in the print station,

FIG. 5 is a schematic perspective view showing principal components of a printing section Bb,

FIG. 6 is a cutaway side view showing vicinity of linear guides 30, and

FIG. 7 is a cutaway front view showing a portion of the vicinity of the linear guides 30.

### DESCRIPTION OF THE PREFERRED EMBODIMENT

A preferred embodiment of the present invention will be described with reference to the accompanying drawings.

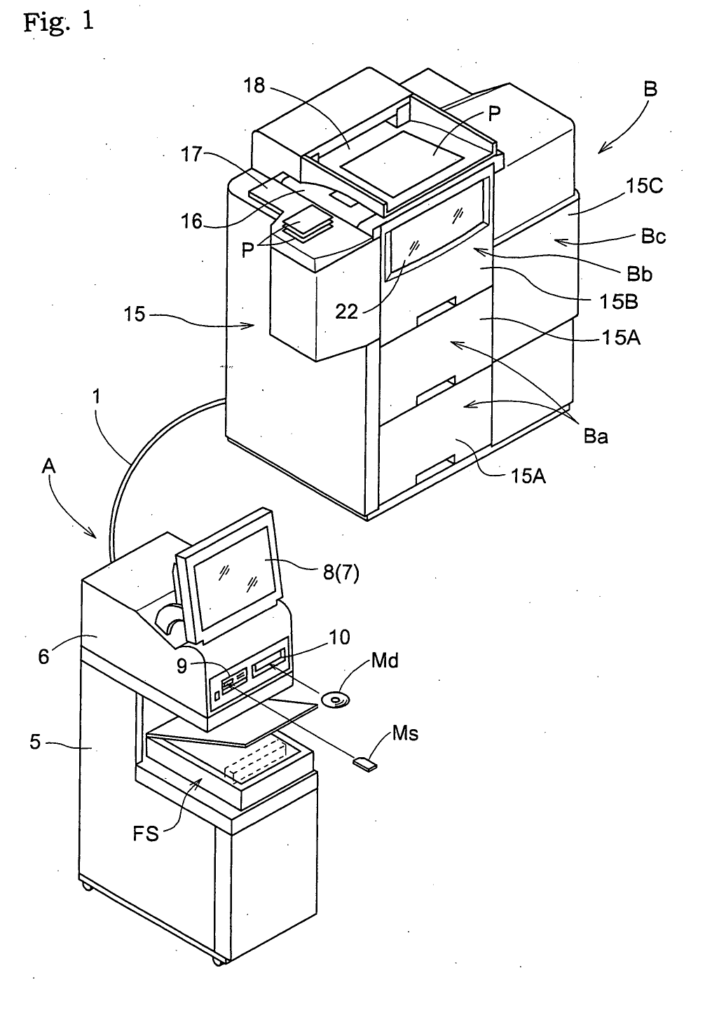

An ink jet print system shown in FIG. 1 consists essentially of a receiving station A for receiving image data and customer's order information from various kinds of recording media Md, Ms, etc. and for effecting a correction thereof when needed, and of a print station B for printing the image data transmitted from the receiving station A via a communication cable 1 on a print paper P as an output medium (an example of print medium) according to the customer's order information.

Referring first to the receiving station A, on the top of a wagon type frame body 5, there are mounted a receiving apparatus body 6 functioning as an image processing apparatus and a liquid crystal display 8 having a touch panel 7 as its display screen. At a vertically intermediate position of the frame body 5, there is mounted a flat-bed scanner FS. In the front face of the frame body 5, there are mounted a semiconductor drive 9 for reading image data stored in a semiconductor type recording medium Ms such as a flash memory, and a disc drive 10 for reading image data stored in a disc type-recording media Md such as a CD-R, DVD, etc.

Referring next to the print station B, at a lower portion of a frame body 15, there are provided two paper magazine storing sections Ba and at an upper portion of the frame body 15, there is provided a printing section Bb. Further, at a lateral side of the frame body 15, there is provided an ink cartridge section Bc. Further, on the top face of the frame body 15, there are mounted a sorting section 17 to which relatively small print papers P are fed via a transverse belt 16 and a rack section 18 for receiving relatively large print papers P.

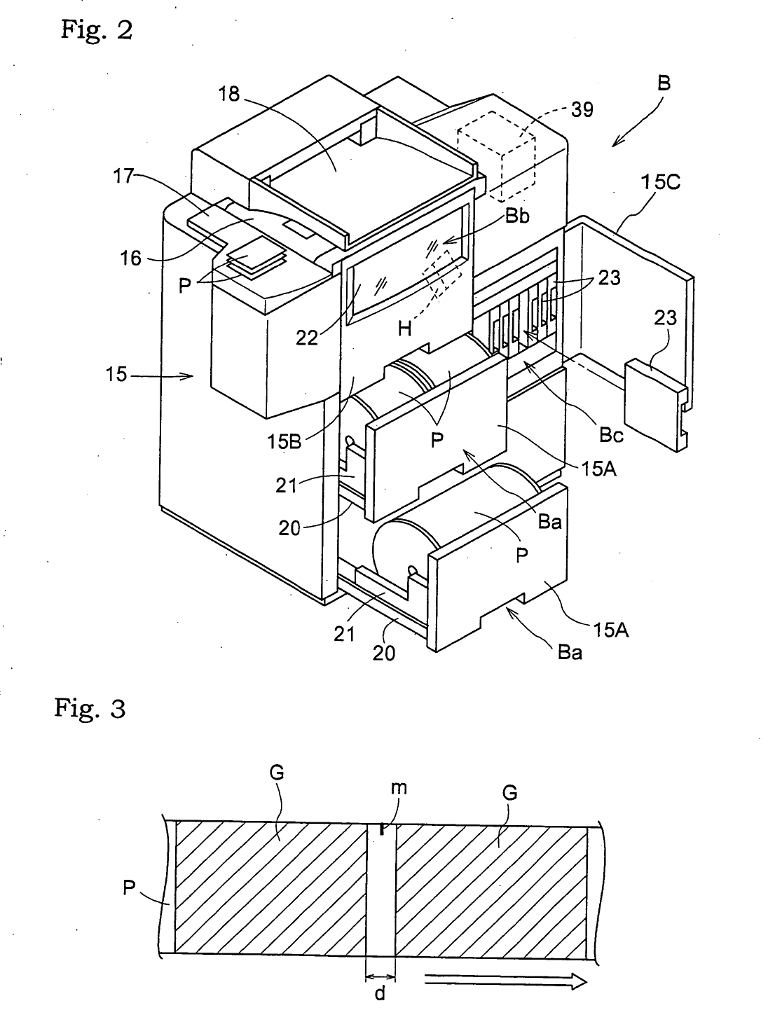

As shown in FIG. 2, each of the two paper magazine storing sections Ba includes a drawer 20 which can be opened/closed together with a front wall member 15A by a sliding movement in the fore and aft direction. And, to this drawer 20, there is set a magazine 21 storing therein a roll of the print paper P. The printing section Bb includes a wall member 15B having a window 22 formed of a transparent resin plate. And, a print head H is disposed inside this wall member 15B. The print head H is configured for discharging ink droplets onto the print paper P via a plurality of nozzles by a discharge control mechanism (not shown), thereby to print an image thereon with a resolution of about 720 dpi in a sub scanning direction and a main scanning direction. The ink cartridge section Bc includes a wall member 15C which can be pivotally opened/closed about a vertical axis. And, inside this wall member 15C, a plurality of ink cartridges 23 can be removably inserted. The ink cartridges 23 consist of seven tanks charged with inks of black (K), light black (LK), cyan (C), magenta (M), light cyan (LC), light magenta (LM) and yellow (Y).

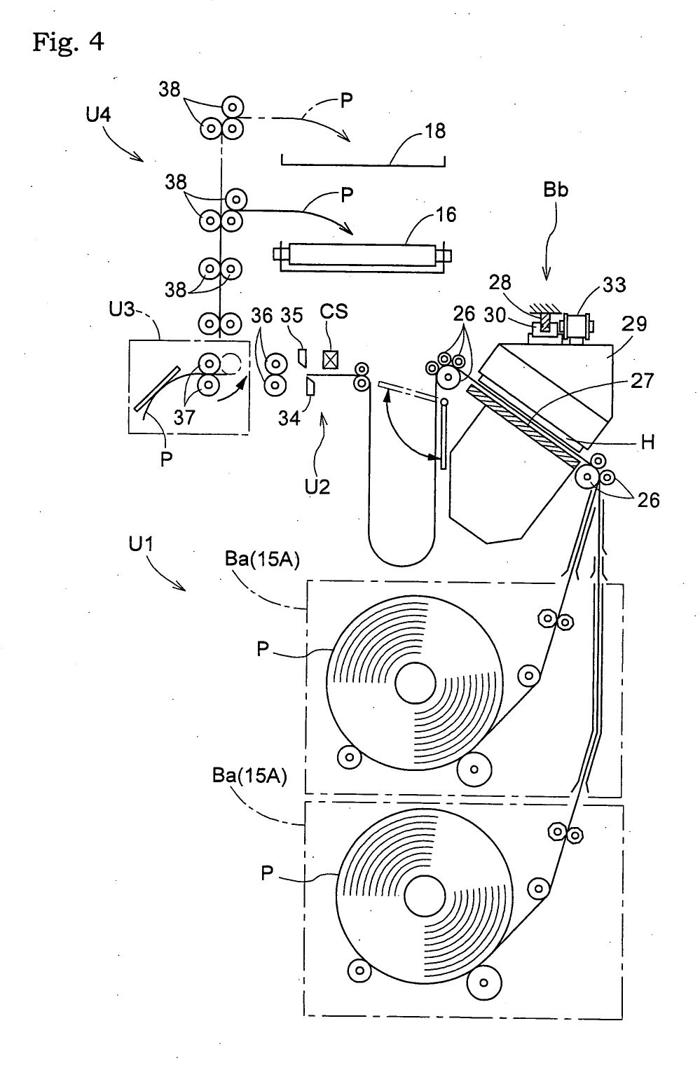

As shown in FIG. 4, when a printing operation of image data on the print paper P is to be effected, the print paper P is drawn out of one of the two paper magazine storing sections Ba and transported to the printing section Bb by a pre-transporting unit U1 and on this paper, the printing operation of the image data is effected by the print head H. In succession, the print paper P thus printed is cut by a cutter unit U2 into a print size and reversed between the front and back faces thereof by a reversing unit U3. Then, from this reversing unit U3, the paper P is transported by a post-transporting unit U4 to the transverse belt 16 or to the rack section 18 mounted on the top of the frame body.

The printing section Bb includes a pair of clamping type transport rollers 26 (an example of transport mechanism) for transporting the print paper P, a guide plate 27 for supporting and guiding the print paper P from its back face and the above-described print head H. The guide plate 27 defines a number of small through holes (not shown), so that the print paper P may be transported along the sub scanning direction while being pressed against the guide plate 27 by means of a negative pressure developed by an air current drawn through the through holes from the front face to the back face of the guide plate 27.

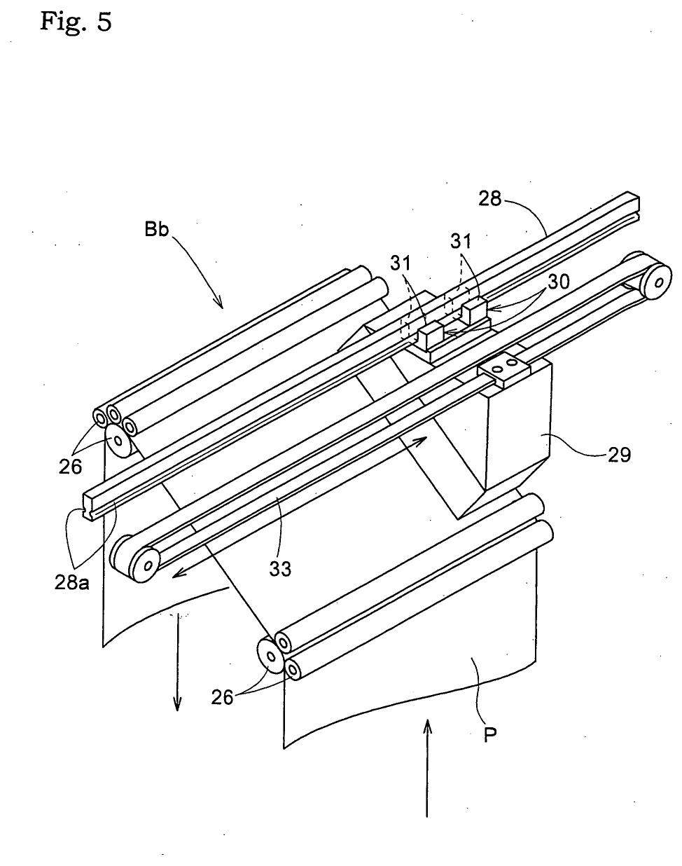

As shown in FIG. 4 and FIG. 5, upwardly of the guide plate 27, there is disposed a single guide rail 28 extending along the main scanning direction (aligned with the width direction of the print paper P) normal to the sub scanning direction. From this guide rail 28, a carriage 29 is slidably suspended via two circulatory type rolling guide mechanisms 30 (to be referred to as “linear guides 30” hereinafter). And, to the bottom face of the carriage 29, there is mounted the print head H having a plurality of arrays of nozzles (not shown). The two linear guides 30 are fixed and spaced apart from each other in the main scanning direction on the top face of the carriage 29.

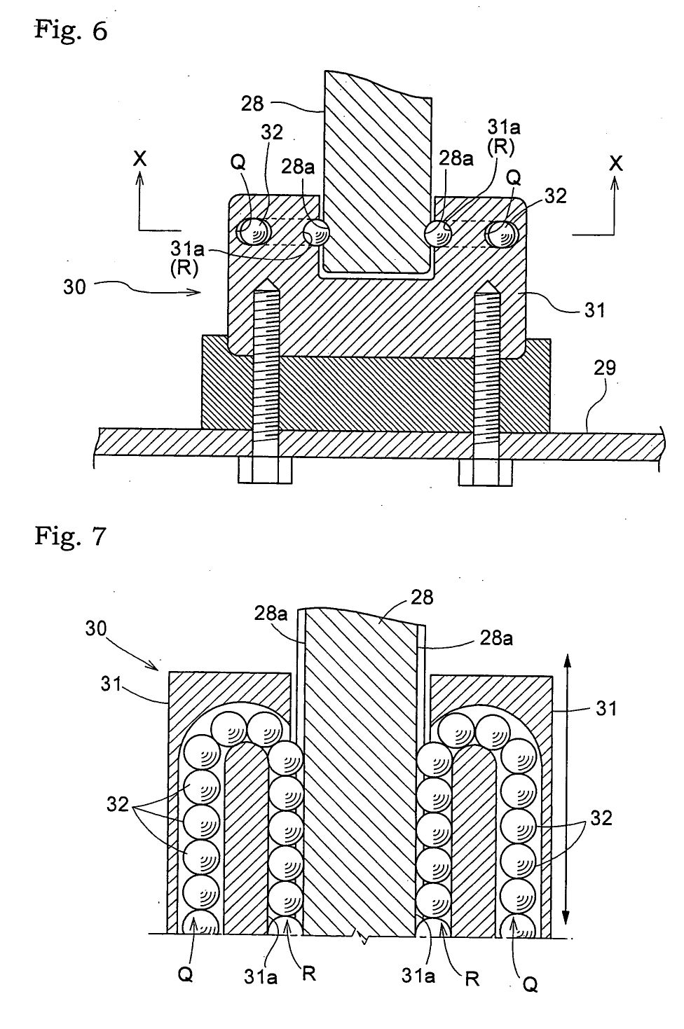

As shown in FIGS. 6 and 7, each linear guide 30 includes a slider 31 engaged with the guide rail 28 and ball receiving grooves 31a (their straight extending portions form load regions R to be described later) along two faces of the slider 31 opposing to the opposed lateral faces of the guide rail 28. On the other hand, the guide rail 28 defines a pair of ball receiving grooves 28a corresponding and opposed to the ball receiving grooves 31a of the slider 31. These ball receiving grooves 28a and 31a together form an endless ball path groove Q which receives therein a number of or a series of roller members which are provided as steel balls in this embodiment.

In operation, when the slider 31 is moved, the respective balls 32 roll within the ball path groove Q, so that the series of the roller members effect a circulatory movement, thereby to significantly reduce the resistance against the movement of the slider 31. These linear guides 30 are configured as preloaded linear guides wherein a preload is applied to the steel balls 32 in the load regions R in order to reduce or eliminate looseness between the carriage 29 and the guide rail 28 with respect of the direction normal to the main scanning direction (i.e. the sub scanning direction and the direction normal to the plane of the print paper P). And, the steel balls 32 employed are of a sufficiently small diameter for substantially preventing ripple in the carriage 29 relative to the guide rail 28, thereby to avoid streak-like irregularity defect in the image to be outputted on the print paper P. Incidentally, the carriage 29 including the print head H weighs about 3 kg. And, the appropriate size (the diameter of about 2.8 mm, that is, 7/64 inch=25.4 mm×7/64) of the steel balls 32 needed and sufficient for avoiding the streak-like irregularity defect in the outputted image has such a value that was experimentally found suitable for the carriage 29 weighing about 3 kg or less, that is, a value sufficient for supporting the carriage 29 of about 3 kg and that was found to be effective in substantially avoiding the streak-like irregularity defect in the outputted image since ripple resulting therefrom is of a sufficiently small amount and of a sufficiently high frequency. Hence, if the weight of the carriage 29 exceeds 3 kg, the above size of the steel ball 32 will result in insufficient strength, hence, inappropriate.

Further, the roller members employed in the linear guides 30 are not limited to the steel balls 32 (i.e. spheres) described above, but can be steel rollers (cylindrical) having a diameter of about 2.8 mm.

The carriage 29 is operable back and forth along the main scanning direction by means of a drive mechanism consisting essentially of an endless flat belt 33 whose portion is secured to the carriage 29 and a motor (not shown) for driving this flat belt 33. Further, the print head H employed in this embodiment is adapted for selectively providing a plurality of sizes of ink droplets through adjustment of the driving electric power. Hence, when a printing operation based on image date is effected, the print head H can express gradation in the printed image based on the gradation of the image data, through adjustment of the number of ink droplets per pixel and the size of each ink droplet.

Referring back to FIG. 4, the cutter unit U2 includes a fixed blade 34, a movable blade 35, a cutting position sensor CS having a reflection type optical sensor, and a discharge roller pair 36 for discharging the print paper P. Incidentally, when a printing operation of print data is effected at the printing section Bb, as shown in FIG. 3, images are printed in areas G spaced apart by a gap (d) therebetween and a cut mark (m) is formed in this gap (d). Hence, when a cutting operation of the print paper is effected by the cutter unit U2, based on a detection of the cut mark (m) by the cut position sensor CS, an area of the paper slightly wider than the gap (d) is cut away, using the cut mark (m) as reference, whereby this cutting operation is effected in such a way not to leave any margins around the image even in a borderless print. The cut print paper P is discharged by the discharge roller pair 36 to the reversing unit U3.

The reversing unit U3 includes a clamp roller pair 37 for clamping the print paper P, a transport drive mechanism (not shown) for forwardly and reversely driving the clamp roller pair 37, and a reverse mechanism for reversing the clamp roller pair 37 by 90 degrees about the respective axis of the rollers. In operation, the print paper P fed from the cutter unit U2 from the leading end of the paper is further transported by the clamp roller pair 37 to position where the terminal end of the paper is transported. Then, as indicated by an arrow in FIG. 4 the unit is rotated by 90 degrees and the clamp roller pair 37 is reversed, whereby the print paper P from its terminal end is fed to the post-transporting unit U4.

The post-transporting unit U4 includes a plurality of transport rollers 38 for transporting the print paper P and a path switchover mechanism (not shown) for selectively feeding the print paper P transported by the transport roller 38 to either the transverse belt 16 or the rack section 18.

Incidentally, the ink reserved in each ink cartridge 23 of the ink cartridge section Bc is stored in a reserve tank 39 (see FIG. 2) and the ink is fed from this reserve tank 39 via a flexible pipe (not shown) to the print head H. By reserving the ink from the ink cartridge 23 in the reserve tank 39, the ink cartridge 23 when emptied can be replaced by a new one without interrupting an ongoing printing operation.

1. An ink jet printer, according to the present invention, comprising:
a print head operable back and forth along a main scanning direction;
a transport mechanism for transporting a print medium along a sub scanning direction intersecting the main scanning direction;
a discharge control mechanism for causing ink to be discharged from a nozzle of the print head, and
the print head being mounted on a carriage supported, via a circulatory rolling guide mechanism, on a guide rail extending along the main scanning direction;
wherein said ink jet printer outputs on the print medium an image having resolution of 700 dpi or higher; the circulatory rolling guide mechanism is configured as a preloaded type mechanism providing its roller members with a preload; and said roll members of the circulatory rolling guide mechanism have a diameter of about 2.8 mm or less.

2. The ink jet printer according to claim 1, wherein said carriage weighs about 3 kg or less.
